(19) United States
(12) Patent Application Publication
(10) Pub. No.: US 2026/0297900 A1
(43) Pub. Date: Oct. 1, 2026

(54) WORKING VEHICLE

(71) Applicant: TAKEUCHI MFG. CO., LTD., Hanishina-gun (JP)

(72) Inventors: Kenichi Tanaka, Hanishina-gun (JP); Takahiro Watanabe, Hanishina-gun (JP)

(73) Assignee: TAKEUCHI MFG. CO., LTD., Hanishina-gun (JP)

(21) Appl. No.: 19/576,047

(22) Filed: Mar. 24, 2026

(30) Foreign Application Priority Data
Mar. 27, 2025 (JP) 2025-054184

(51) Int. Cl. E02F 9/20; B60L 1/00; B60L 1/06; H02M 7/00

(52) U.S. Cl. CPC E02F 9/2095; B60L 1/003; B60L 1/06; H02M 7/003

(57) ABSTRACT

A working vehicle according to the present invention includes a hydraulically operating working device, an electric motor as a drive source of the working device, and a battery supplying electricity, wherein a first electrical device, a second electrical device, and a third electrical device supplied with electricity from the battery are provided. The first electrical device has a first fuse mounting base for mounting a first fuse. The second electrical device has a second fuse mounting base for mounting a second fuse. A fuse serving both as a fuse for the first electrical device and as a fuse for the second electrical device is provided as the first fuse. A fuse for the third electrical device is provided as the second fuse.

### CROSS-REFERENCE TO RELATED APPLICATION

This application is based upon and claims the benefit of priority of the prior Japanese Patent Application No. P2025-054184, filed on Mar. 27, 2025, and the entire contents of which are incorporated herein by reference.

### TECHNICAL FIELD

The present invention relates to a working vehicle.

### BACKGROUND ART

As an example of a working vehicle, a hydraulic excavator, a track loader or the like having a lower body with a traveling crawler or tire installed thereon, an upper body arranged above the lower body, and a working device installed at the lower body or the upper body and operating hydraulically (that is, with hydraulic oil having a predetermined pressure) is known according to the related art.

Recently, a working vehicle having an electric motor instead of a conventional engine as a drive source of a working device has been developed (refer to JP-A-2007-325431).

### SUMMARY OF INVENTION

### TECHNICAL PROBLEM

Normally, as the working vehicle becomes smaller, the space where a device is installed becomes narrower. Therefore, the configuration and arrangement of the device and the securing of an installation space therefor are persistent problems.

In the presence of such problems, particularly in a working vehicle having a configuration with a closed-type cabin, a heater device for heating the inside of the cabin and defrosting the window glass thereof needs to be installed.

In the case of installing a heater device, according to the related art, it is common to employ the configuration given below. Specifically, in a battery pack accommodating a battery and provided with a power feed relay and a connector for cable connection or the like, a connector for the heater device is additionally provided and a cable for the heater device is thus connected to feed power to the heater device. In this case, a fuse for the heater device is separately placed inside a separately provided fuse box.

Therefore, to add the connector for the heater device to the battery pack, the shape of the battery pack used in the case where the heater device is not installed must be changed. Also, a cable (for example, a cable from the inverter to the heater device) and a space for accommodating fuses (for example, a space where a fuse box is installed) need to be secured on the vehicle side.

### SOLUTION TO PROBLEM

The present invention has been accomplished under the above-described circumstances and an object thereof is to provide a working vehicle in which, in the case of installing a heater device, a fuse for the heater device, a fuse for an inverter, and a cable can be arranged in a smaller space without adding a connector to a battery pack used in the case where a heater device is not installed and without adding a fuse box on the vehicle side.

The present invention solves the above-described problems by a solution as described below as an embodiment.

A working vehicle according to an embodiment is a working vehicle including a hydraulically operating working device, and the working vehicle includes an electric motor serving as a drive source of the working device, and a battery supplying electricity, wherein a first electrical device, a second electrical device, and a third electrical device that are supplied with electricity from the battery are provided, the first electrical device has a first fuse mounting base for mounting a first fuse, the second electrical device has a second fuse mounting base for mounting a second fuse, a fuse serving both as a fuse for the first electrical device and as a fuse for the second electrical device is provided as the first fuse, and a fuse for the third electrical device is provided as the second fuse.

### ADVANTAGEOUS EFFECTS OF INVENTION

In the working vehicle according to the embodiment, in the case of installing a heater device, a fuse for the heater device, a fuse for an inverter, and a cable can be arranged in a smaller space without adding a connector to a battery pack used in the case where a heater device is not installed and without adding a fuse box on the vehicle side.

### BRIEF DESCRIPTION OF DRAWINGS

FIG. 1 is a perspective view showing an example of a working vehicle according to an embodiment of the present invention.

FIG. 2 is a back view showing an example of a battery pack, an inverter, a heater device, and an electric motor of the working vehicle shown in FIG. 1.

FIG. 3 is a bottom view showing an example of the battery pack, the inverter, the heater device, and the electric motor of the working vehicle shown in FIG. 1.

FIG. 4 is a perspective view showing an example of the inverter of the working vehicle shown in FIG. 1.

FIG. 5 is a perspective view showing an example of a first inverter of the working vehicle shown in FIG. 1.

FIG. 6 is a perspective view showing an example of a second inverter of the working vehicle shown in FIG. 1.

FIG. 7 is an electrical circuit view of the battery pack, the inverter, and the heater device of the working vehicle shown in FIG. 1.

### DESCRIPTION OF EMBODIMENTS

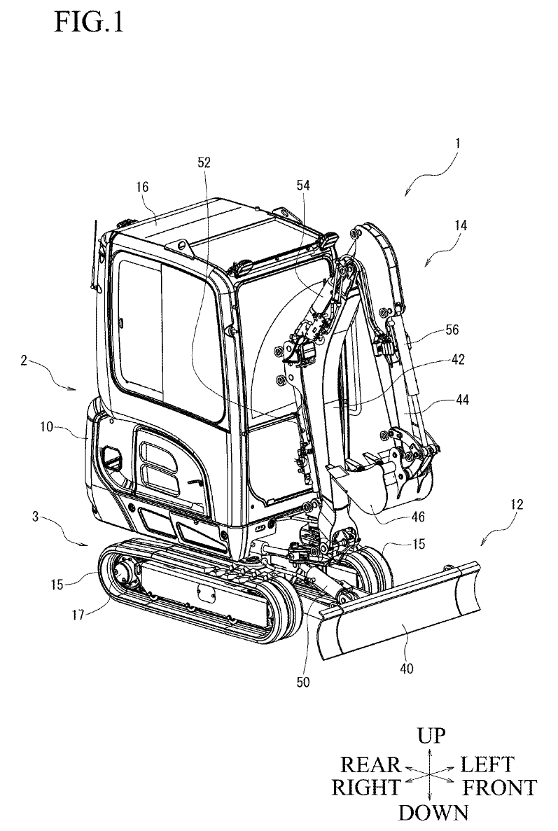

Hereinafter, an embodiment of the present invention will be described in detail with reference to the drawings. FIG. 1 is a schematic view (perspective view from above a right front part) showing an example of a working vehicle 1 according to the present embodiment. For the sake of convenience of description, there are cases where upward and downward, left and right, and forward and backward directions are indicated by arrows in the drawings. Also, there are cases where members having the same function are denoted by the same sign in all the drawings for illustrating the embodiment and the repeated description thereof is omitted.

First, the overall configuration of the working vehicle 1 will be described. A hydraulic excavator will be described as an example of the working vehicle 1. However, the working vehicle 1 is not limited to the hydraulic excavator.

As shown in FIG. 1, the working vehicle 1 has a lower body 3 provided with a traveling device, and an upper body 2 arranged above the lower body 3. This working vehicle 1 has working devices 12, 14 that operate hydraulically (with hydraulic oil having a predetermined pressure).

The upper body 2 has a device compartment 10 in which a drive source 20 (described later) of the working devices 12, 14, or the like, is installed. Also, a cabin 16 provided with an operation device (not illustrated) with which an operator on board carries out operations for traveling and work is provided. The cabin 16 according to the present embodiment is a closed type (cabin). Therefore, a heater device 60 for supplying warm air to perform the heating of the inside of the cabin and the defrosting of the window glass thereof is provided. As an example, the heater device 60 is configured with two heater devices (first device 61, second device 62). However, this configuration is not limiting.

As an example of the traveling device, a pair of left and right crawlers 15 are provided. However, the traveling device is not limited to the crawlers 15 and may employ a configuration having tires instead of the crawlers 15 (not illustrated). The crawlers 15 are driven by a traveling hydraulic motor 17.

As an example of the working device 12, a blade 40 is provided. The blade 40 is installed at the lower body 3 so as to be able to swing upward and downward (including forward and backward components). The blade 40 is driven by a hydraulic cylinder (blade cylinder) 50. However, the working device 12 is not limited to the above-described configuration.

As an example of the working device 14, a boom 42, an arm 44, and an attachment (in the present embodiment, a bucket) 46 are provided. However, the attachment 46 is not limited to the bucket. The boom 42 is installed at the upper body 2 so as to be able to swing upward and downward (including forward and backward components) (a boom bracket may or may not be provided in between). The arm 44 is installed at the boom 42 so as to be able to swing upward and downward (including forward and backward components). The attachment 46 is installed at the arm 44 so as to be able to swing upward and downward (including forward and backward components). The boom 42 is driven by a hydraulic cylinder (boom cylinder) 52. The arm 44 is driven by a hydraulic cylinder (arm cylinder) 54. The attachment 46 is driven by a hydraulic cylinder (bucket cylinder) 56. However, the working device 14 is not limited to the above-described configuration.

The working vehicle 1 has the drive source 20, a hydraulic pump (not illustrated) driven by the drive source 20, a control valve (not illustrated) and the like, as a drive mechanism for driving the above-described traveling hydraulic motor 17 and hydraulic cylinders 50, 52, 54, 56. One or a plurality of hydraulic pumps are provided in accordance with the configurations, loads and the like of the working devices 12, 14 and the traveling device or the like.

In the working vehicle 1 having the above-described configuration, the operator operates the operation device (not illustrated) or the like and thus performs control to activate the control valve to supply hydraulic oil with a predetermined pressure sent out from the hydraulic pump to the traveling hydraulic motor 17 and the hydraulic cylinders 50, 52, 54, 56. Thus, the traveling of the working vehicle 1 and the work by the working devices 12, 14 can be performed.

The working vehicle 1 has an electric motor as the above-described drive source 20. As an example, the electric motor 20 is an AC motor and the specifications thereof (the rated output thereof or the like) are set as appropriate in accordance with the number of driven devices and the rated output thereof or the like. In the present embodiment, two electric motors 20 (first motor 20A, second motor 20B) are provided. However, the number of electric motor 20 is not limited to two.

Also, as an example, the driven device driven by the electric motor 20 is a hydraulic pump that sends out hydraulic oil with a predetermined pressure which causes the working devices 12, 14 or a traveling device, a slewing device or the like to operate. Alternatively, as another example, the driven device is the compressor of an air conditioner that performs air conditioning in the cabin 16. However, the driven device is not limited to these examples.

Also, the working vehicle 1 has a battery (for example, a lithium-ion rechargeable battery) that supplies electricity for driving the electric motor 20. In the present embodiment, the battery is configured in the form of a battery pack 30 accommodating this battery and provided with a power feed relay (not illustrated) and connectors 30A, 30B or the like (described later) for cable connection. Moreover, an inverter that converts the electricity supplied from this battery (that is, the battery pack 30) (from direct current to alternating current or the like) and supplies the converted electricity to the electric motor 20 is provided. In the present embodiment, two inverters 21, 22 that supply electricity, corresponding to the two electric motors 20A, 20B, respectively, are provided. The inverter 21 is provided with a U terminal 21D, a V terminal 21E, and a W terminal 21F for electrically connecting to the first motor 20A. The inverter 22 is provided with a U terminal 22D, a V terminal 22E, and a W terminal 22F for electrically connecting to the second motor 20B. In the present application, there are cases where the inverter 21 is referred to as a “first electrical device”. Also, there are cases where the inverter 22 is referred to as a “second electrical device”. However, the number of inverters is not limited to two.

The above-described electric motors 20A, 20B, inverters 21, 22, and battery pack 30 are installed in the device compartment 10. Since the space where devices are installed becomes narrower as the working vehicle 1 becomes smaller, as described above, achieving an efficient configuration and arrangement of the devices and securing an installation space therefor are problems.

Also, the working vehicle 1 is provided with the heater device 60, as described above, which in the present embodiment, operates with electricity supplied from the battery (battery pack 30). Therefore, there is a problem in that a space for accommodating a cable (described later) for supplying electricity to the heater device 60 and a fuse (described later) for protecting the heater device 60 must be secured. In the present application, there are cases where the heater device 60 is referred to as a “third electrical device”.

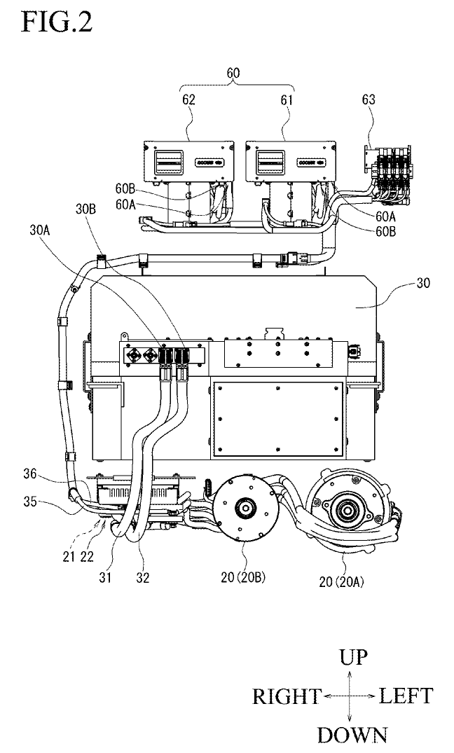

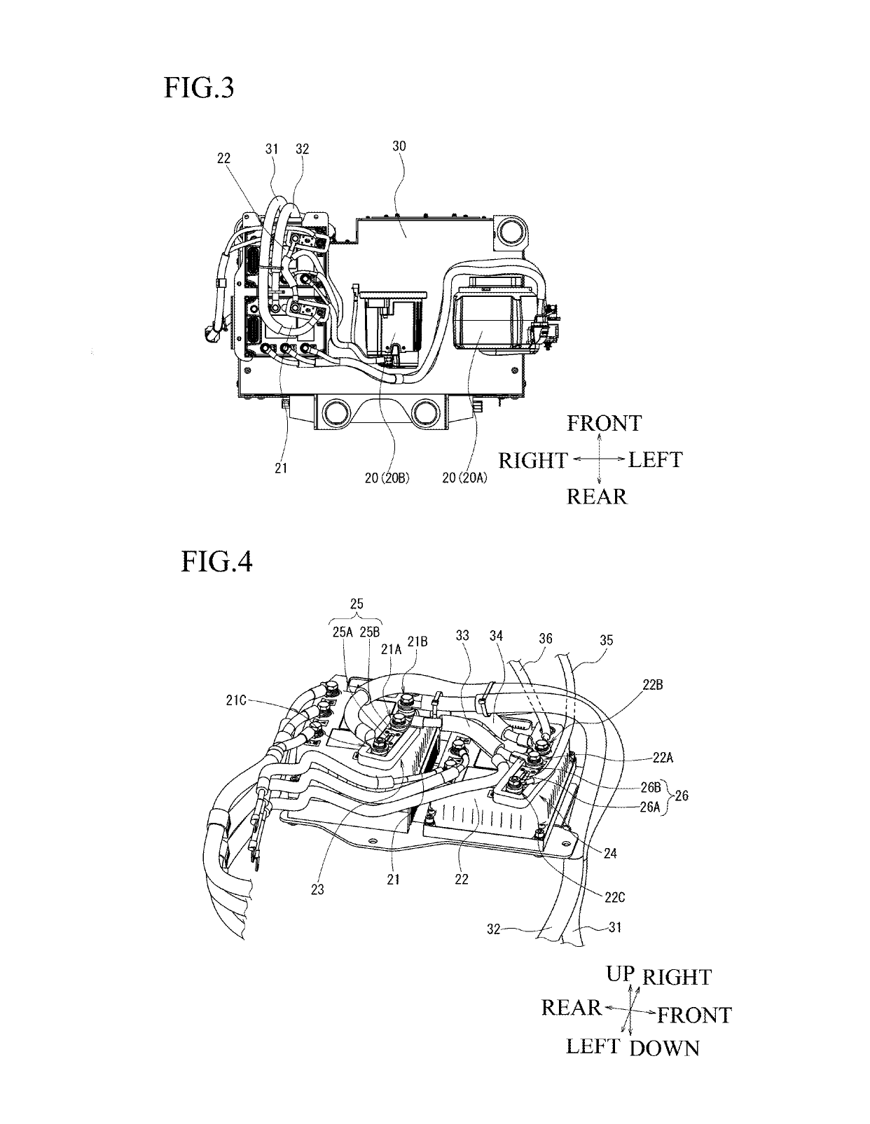

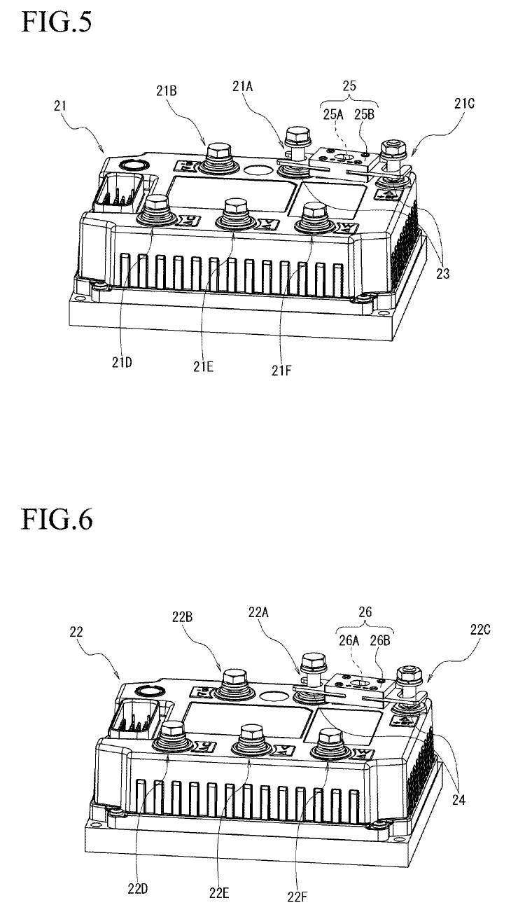

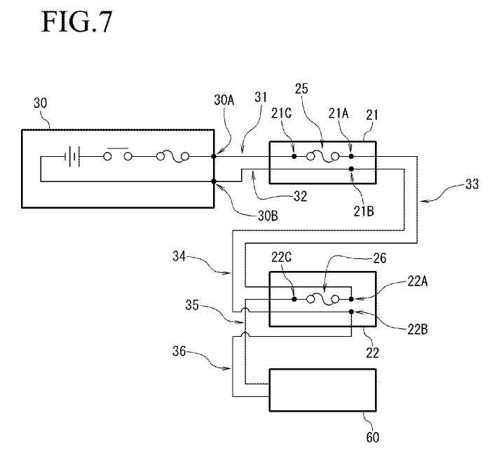

In the present embodiment, the problem is solved by having the following configuration. Now, a connection structure for supplying electricity from the battery (battery pack 30) to the inverters 21, 22 and the heater device 60 or the like will be described with reference to the drawings. First, FIG. 2 is a back view mainly showing the battery pack 30, the inverters 21, 22, the heater device 60, and the electric motor 20, and FIG. 3 is a bottom view thereof. FIG. 4 is an enlarged view (perspective view) mainly showing the inverters 21, 22. FIG. 5 is an enlarged view (perspective view) of the inverter 21, and FIG. 6 is an enlarged view (perspective view) of the inverter 22. FIG. 7 is an electrical circuit view showing the electrical connection of the battery pack 30, the inverters 21, 22, and the heater device 60.

First, the battery (battery pack 30) and the inverter 21 are electrically connected to each other. Specifically, the connector (positive electrode) 30A of the battery pack 30 and an auxiliary terminal 21C of the inverter 21 are connected to each other via a first cable 31. Also, the auxiliary terminal 21C of the inverter 21 and a positive terminal 21A of the inverter 21 are connected to each other via a first fuse 25. Also, the connector (negative electrode) 30B of the battery pack 30 and a negative terminal 21B of the inverter 21 are connected to each other via a second cable 32. The auxiliary terminal 21C according to the present embodiment is an auxiliary terminal of the same polarity as the positive terminal 21A (that is, a positive electrode) and is provided as a support part (connection part) of the first cable 31 and also as an element of a first fuse mounting base 23 for mounting the first fuse 25. Also, the first fuse 25 has a configuration in which a fuse main body 25A is held by a fuse holding member 25B so as to be able to be energized. Also, the first fuse mounting base 23 provided at the inverter 21 is configured to engage and fix the two end parts of the fuse holding member 25B, using a terminal base part of the positive terminal 21A and the auxiliary terminal 21C as a base. However, these configurations of the first fuse mounting base 23 are not limiting.

With this configuration, electricity can be supplied from the battery pack 30 to the inverter 21. Also, with a configuration in which the first fuse 25 is provided upstream (that is, to the battery pack 30 side) from the positive terminal 21A of the inverter 21 in the current supply, the inverter 21 can be protected (for example, protected from unexpected overcurrent or the like).

Also, the inverter 21 and the inverter 22 are electrically connected in parallel. Specifically, the positive terminal 21A of the inverter 21 and a positive terminal 22A of the inverter 22 are connected to each other via a third cable 33. Also, the negative terminal 21B of the inverter 21 and a negative terminal 22B of the inverter 22 are connected to each other via a fourth cable 34.

In this configuration, since the inverter 21 (specifically, the positive terminal 21A, the negative terminal 21B, the auxiliary terminal 21C) is provided in-between, electricity can be supplied from the battery pack 30 to the inverter 22. Also, the first fuse 25 for the inverter 21 can be also used as the fuse for the inverter 22. That is, since the above-described connection structure provides a configuration in which the first fuse 25 is provided upstream (that is, to the battery pack 30 side) from the positive terminal 22A of the inverter 22 in the current supply, the inverter 22 can be protected (for example, protected from unexpected overcurrent or the like). Originally, it is normal to employ a configuration in which the fuse for the inverter 21 is mounted on the first fuse mounting base 23 of the inverter 21 and in which the fuse for the inverter 22 is mounted on a second fuse mounting base 24 of the inverter 22. In contrast, with the above-described connection structure according to the present embodiment, a configuration in which the first fuse 25 mounted on the first fuse mounting base 23 is used both as the fuse for the inverter 21 and as the fuse for the inverter 22 can be implemented. That is, the second fuse mounting base 24 of the inverter 22 can be provided as a base for mounting the fuse for another electrical device (other than the inverter). Thus, space saving can be achieved for the space for mounting the fuse.

Moreover, the inverter 22 and the heater device 60 are electrically connected in parallel. Specifically, the positive terminal 22A of the inverter 22 and an auxiliary terminal 22C of the inverter 22 are connected to each other via a second fuse 26 (a fuse main body 26A and a fuse holding member 26B). Also, the auxiliary terminal 22C of the inverter 22 and a positive terminal 60A of the heater device 60 are connected to each other via a fifth cable 35 and a power feed relay 63. Also, a negative terminal 60B of the heater device 60 and the negative terminal 22B of the inverter 22 are connected to each other via a sixth cable 36. The auxiliary terminal 22C according to the present embodiment is an auxiliary terminal of the same polarity as the positive terminal 22A (that is, a positive electrode) and is provided as a support part (connection part) of the fifth cable 35 and also as an element of the second fuse mounting base 24 for mounting the second fuse 26. Also, the second fuse 26 has a configuration in which the fuse main body 26A is held by the fuse holding member 26B so as to be able to be energized. Also, the second fuse mounting base 24 provided at the inverter 22 is configured to engage and fix the two end parts of the fuse holding member 26B, using a terminal base part of the positive terminal 22A and the auxiliary terminal 22C as a base. However, these configurations of the second fuse mounting base 24 are not limiting.

In this configuration, since the inverter 21 (specifically, the positive terminal 21A, the negative terminal 21B, the auxiliary terminal 21C) and the inverter 22 (specifically, the positive terminal 22A, the negative terminal 22B, the auxiliary terminal 22C) are provided in-between, electricity can be supplied from the battery pack 30 to the heater device 60. Also, since the second fuse 26 is provided upstream (that is, to the battery pack 30 side) from the positive terminal 60A in the current supply, the heater device 60 can be protected (for example, protected from unexpected overcurrent or the like). As described above, the second fuse mounting base 24 of the inverter 22 can be provided as a base for mounting the fuse for another electrical device (other than the inverter). Thus, in the present embodiment, a configuration in which this second fuse mounting base 24 is utilized as a base for mounting the fuse for the heater device 60 (that is, the second fuse 26) is provided. Therefore, space saving can be achieved for the space for mounting the fuse.

Moreover, the electricity for activating the heater device 60 can be supplied via the inverter 21 or the inverter 22 instead of being directly supplied from the battery (battery pack 30). Thus, a connector for supplying electricity to the heater device 60 need not be added to the battery pack 30. Therefore, the above-descried problem, that is, the problem of having to change the shape of a battery pack for a working vehicle having a configuration in which a heater device is not installed, in order to add a connector for a heater device to the battery pack, can be solved. Specifically, a battery pack for a working vehicle having a configuration in which a heater device is not installed can be used as the battery pack 30 for the working vehicle 1 having a configuration in which the heater device 60 is installed in the present embodiment, with a configuration in which the outer shape of the battery pack (at least of the connector) is not changed. However, as for internal devices, it is a matter of course that devices, a substrate, and the like that are necessary for the heater device 60 are provided.

In the above-described configuration, in order to properly protect the first electrical device (as an example, the inverter 21), the second electrical device (as an example, the inverter 22), and the third electrical device (as an example, the heater device 60) with the first fuse 25 and the second fuse 26, it is important that the third electrical device is a device having a lower rated current than the total of the rated currents of the first electrical device and the second electrical device.

The other mechanisms for traveling and work in the working vehicle 1 according to the present embodiment are similar to those in a known working vehicle (hydraulic excavator) and therefore the detailed description thereof is omitted.

As described above, it is preferable that the present invention includes the configurations given below.
(1) A working vehicle according to an embodiment is a working vehicle including a hydraulically operating working device, and the working vehicle includes an electric motor serving as a drive source of the working device, and a battery supplying electricity, wherein a first electrical device, a second electrical device, and a third electrical device that are supplied with electricity from the battery are provided, the first electrical device has a first fuse mounting base for mounting a first fuse, the second electrical device has a second fuse mounting base for mounting a second fuse, a fuse serving both as a fuse for the first electrical device and as a fuse for the second electrical device is provided as the first fuse, and a fuse for the third electrical device is provided as the second fuse.
(2) In the working vehicle according to the above aspect (1), it is preferable that a cable for supplying electricity from the battery is connected to an electrode terminal of the first electrical device, an electrode terminal of the first electrical device is connected to an electrode terminal of the second electrical device in parallel, an electrode terminal of the second electrical device is connected to an electrode terminal of the third electrical device in parallel, and electricity from the battery is supplied to the third electrical device.
(3) In the working vehicle according to the above aspect (1) or (2), it is preferable that the third electrical device is a device having a lower rated current than a total of rated currents of the first electrical device and the second electrical device.
(4) In the working vehicle according to any one of the above aspects (1) to (3), it is preferable that the first electrical device and the second electrical device are inverters that supply electricity to the electric motor.
(5) In the working vehicle according to any one of the above aspects (1) to (4), it is preferable that the third electrical device is a heater device that supplies warm air.

According to the present invention, in the case of installing a heater device in a working vehicle, a fuse for the heater device, a fuse for an inverter, and a cable can be arranged in a smaller space without adding a connector to a battery pack used in the case where a heater device is not installed and without adding a fuse box on the vehicle side.

The present invention is not limited to the above-described embodiment (hydraulic excavator). For example, while a hydraulic excavator has been described as an example of the working vehicle 1, the present invention can be similarly applied to other working vehicles (a track loader or the like) having a closed-type cabin. Also, while the inverter 21 has been described as an example of the first electrical device and the inverter 22 has been described as an example of the second electrical device, it is also possible to be similarly applied to other electrical devices. Also, while the heater device 60 has been described as an example of the third electrical device, it is also possible to be similarly applied to other electrical devices.

What is claimed is:

1. A working vehicle comprising a hydraulically operating working device,
the working vehicle comprising an electric motor serving as a drive source of the working device, and a battery supplying electricity, wherein
a first electrical device, a second electrical device, and a third electrical device that are supplied with electricity from the battery are provided,
the first electrical device has a first fuse mounting base for mounting a first fuse,
the second electrical device has a second fuse mounting base for mounting a second fuse,
a fuse serving both as a fuse for the first electrical device and as a fuse for the second electrical device is provided as the first fuse, and
a fuse for the third electrical device is provided as the second fuse.

2. The working vehicle according to claim 1, wherein
a cable for supplying electricity from the battery is connected to an electrode terminal of the first electrical device,
an electrode terminal of the first electrical device is connected to an electrode terminal of the second electrical device in parallel,
an electrode terminal of the second electrical device is connected to an electrode terminal of the third electrical device in parallel, and electricity from the battery is supplied to the third electrical device.

3. The working vehicle according to claim 1, wherein
the third electrical device is a device having a lower rated current than a total of rated currents of the first electrical device and the second electrical device.

4. The working vehicle according to claim 3, wherein
the first electrical device and the second electrical device are inverters that supply electricity to the electric motor.

5. The working vehicle according to claim 3, wherein
the third electrical device is a heater device that supplies warm air.
